(19) United States
(12) Patent Application Publication
(10) Pub. No.: US 2020/0403362 A1
(43) Pub. Date: Dec. 24, 2020

(54) A PLUG FOR USE IN A WIRING DUCT

(71) Applicant: MODULEX INC., Tokyo (JP)

(72) Inventor: Goro TERUMICHI, Tokyo (JP)

(73) Assignee: MODULEX INC., Tokyo (JP)

(21) Appl. No.: 16/976,097

(22) PCT Filed: Feb. 28, 2018
(86) PCT No.: PCT/JP2018/007653

§ 371 Date: Aug. 27, 2020

(51) Int. Cl. H01R 35/04

(52) U.S. Cl. CPC H01R 35/04

(57) ABSTRACT

A wiring duct plug that does not have a movable part for switching and thus has a higher operational reliability is provided.

A plug (wiring duct plug) 2 for use mounted in a wiring duct, in which a plurality of conductive lines are installed, comprises a rotatable rotator 17, a pair of non-movable electrode terminals 2a-c′ and 2d′, and a plurality of movable electrode terminals 2a to 2d. The plurality of movable electrode terminals 2a to 2d rotate with the rotator 17 and are placed either at a connection position for electrically coupling the plurality of conductive lines and the pair of non-movable electrode terminals 2a-c′ and 2d′, or at a release position for releasing electrical connection. At the connection position, among the plurality of movable electrode terminals 2a to 2d, the plurality of movable electrode terminals 2a to 2c whose number of terminals is one or more less than the number of the conductive lines respectively connect to conductive lines whose number of lines is one or more less than the conductive lines, and are joined into one at the base end portion and coupled to the one non-movable electrode terminals 2a-c′. The remaining movable electrode terminal 2d couples the remaining conductive line to the other non-movable electrode terminal 2d′.

### TECHNICAL FIELD

The present invention relates to a wiring duct plug for use mounted in a wiring duct that is installed in a ceiling.

### BACKGROUND

As a plug for use in a wiring duct, a plug having an electrical switching means has been conventionally known (see Patent document 1).

This type of plug is described in a patent publication, as a solution in the abstract of as follow:

“A plug 1 is electrically and mechanically coupled to a power distribution duct 20 in which a plurality of conductors 21 are contained. The plug 1 comprises a plug body 4 that includes an insertion portion 2 inserted into and locked with the power distribution duct 20, and an exposed portion 3 that communicates with the insertion portion 2 and is exposed outside the power distribution duct 20. The insertion portion 2 is provided with a conductive portion 11 that can be electrically connected to an arbitrary conductor 21. The plug 4 is provided with an electrical switching means 10 for switching between arbitrary conductors 21 and electrically connecting an arbitrary conductor 21 to the conductive portion 11.”

### PRIOR ART

### Patent Document

[Patent Document 1]: JP-A-2001-155534

### SUMMARY

### Problems to be Solved by the Invention

According to Patent Document 1, however, the electrical switching means has a movable part for switching, and thus there has been a problem in that its operational reliability is low.

The present invention has been made in view of the circumstance described above. An object of the present invention is to provide a wiring duct plug that does not have any movable part for switching, and thus has an improved operational reliability.

### Means to Solve the Problems

To achieve the object described above, the present invention is characterized in that a wiring duct plug mounted to a duct when used, wherein a plurality of conductive wires are installed in the wiring duct, the plug comprises: a rotatable rotator; a pair of non-movable electrode terminals; and a plurality of movable electrode terminals rotating with the rotator and placed either at a connection position for electrically coupling the plurality of conductive wires to the pair of non-movable electrode terminals, or at a release position for electrically releasing the connection. At the connection position, among the plurality of movable electrode terminals, a plurality of movable electrode terminals, whose number of terminals is one or more less than the number of the plurality of conductive lines, are respectively coupled to conductive lines, whose number of lines is one or more less than the number of the plurality of conductive lines, and the plurality of movable electrode terminals are joined into one at a base end portion and connected to one of the non-movable electrode terminals. The remaining movable electrode terminal couples the rest of the conductive lines to the other non-movable electrode terminal.

### THE EFFECT OF THE INVENTION

According to the present invention, the plurality of movable electrode terminals are joined into one at the base end. Therefore, the plurality of movable electrode terminals, when placed at the connection position, electrically couple the plurality of conductive lines to one of the non-movable electrode terminals. As a result, for example, the plurality of movable electrode terminals can electrically couple any of the plurality of conductive lines to one of the non-movable electrode terminals, without the need of selecting one out of the plurality of conductive lines. In other words, no movable part is required for selecting (switching) one out of the plurality of conductive lines, and thus operational reliability can be improved accordingly. The remaining movable electrode terminal connects the remaining conductive lines to the other non-movable electrode terminal.

### BRIEF DESCRIPTION OF THE DRAWINGS

FIG. 1 is a perspective view of a plug 2.

FIG. 2 is a front view of the plug 2.

FIG. 3 is a right side view of the plug 2, with a portion thereof being omitted.

FIG. 4 is a front view of the plug 2, illustrating an insulation wall 21, movable electrode terminals 2a to 2d, movable signal terminals 2f and 2g, non-movable electrode terminals 2a-c′ and 2d′, and non-movable signal terminals 2f′ and 2g′.

FIG. 5 is a rear view of the plug 2, illustrating the insulation wall 21, the movable electrode terminals 2a to 2d, the movable signal terminals 2f and 2g, the non-movable electrode terminals 2a-c′ and 2d′, and the non-movable signal terminals 2f′ and 2g′.

FIG. 6 is a right side view of the plug 2, illustrating the insulation wall 21, the movable electrode terminals 2a and 2d, the movable signal terminal 2g, the non-movable electrode terminal 2d′, and the non-movable signal terminals 2f′ and 2g′.

FIG. 7A is a cross sectional view taken perpendicular to the longitudinal direction of a wiring duct 1A.

FIG. 7B is a schematic front view of the plug 1 illustrating movable electrode terminals 1a to 1d, and non-movable electrode terminals 1a-c′ and 1d′.

FIG. 7C is a schematic plan view of the plug 1 illustrating the movable electrode terminals 1a, 1b, and 1d.

FIG. 8A is a cross sectional view taken perpendicular to the longitudinal direction of a wiring duct 2A.

FIG. 8B is a schematic front view of the plug 2, illustrating the movable electrode terminals 2a to 2d, the movable signal terminals 2f and 2g, the non-movable electrode terminals 2a-c′ and 2d′, and the non-movable signal terminals 2f′ and 2g′.

FIG. 8C is a schematic plan view of the plug 2, illustrating the movable electrode terminals 2a, 2b, and 2d, and the movable signal terminal 2f.

FIG. 9A is a cross sectional view taken perpendicular to the longitudinal direction of a wiring duct 3A.

FIG. 9B is a schematic front view of a plug 3, illustrating movable electrode terminals 3a, 3b, 3d, and 3e, and non-movable electrode terminals 3ab′ and 3de′.

FIG. 9C is a schematic plan view of the plug 3, illustrating the movable electrode terminals 3a, 3b, 3d, and 3e.

FIG. 10A is a cross sectional view taken perpendicular to the longitudinal direction of a wiring duct 4A.

FIG. 10B is a schematic front view of a plug 4, illustrating movable electrode terminals 4a, 4b, 4d, and 4e, and non-movable electrode terminals 4ab′ and 4de′.

FIG. 10c is a schematic plan view of the plug 4, illustrating the movable electrode terminals 4a, 4b, 4d, and 4e.

FIG. 11A is a perspective view illustrating the plug 1 used in the wiring duct 1A in FIG. 7A.

FIG. 11B is a plan view thereof.

FIG. 11C is a right side view thereof.

FIG. 11D is a left side view thereof.

FIG. 11E is a front view thereof.

FIG. 12A is a perspective view illustrating the plug 2 used in the wiring duct 2A in FIG. 8A.

FIG. 12B is a plan view thereof.

FIG. 12C is a right side view thereof.

FIG. 12D is a left side view thereof.

FIG. 12E is a front view thereof.

FIG. 13A is a perspective view illustrating the plug 3 used in the wiring duct 3A in FIG. 9A.

FIG. 13B is a plan view thereof.

FIG. 13C is a right side view thereof.

FIG. 13D is a left side view thereof.

FIG. 13E is a front view thereof.

FIG. 14A is a perspective view illustrating the plug 4 used in the wiring duct 4A in FIG. 10A.

FIG. 14B is a plan view thereof.

FIG. 14C is a right side view thereof.

FIG. 14D is a left side view thereof.

FIG. 14E is a front view thereof.

FIG. 15A is an enlarged view of the wiring duct 1A in FIG. 7A.

FIG. 15B is an enlarged view of the wiring duct 2A in FIG. 8A.

FIG. 16A is a right side view of the plug 2.

FIG. 16B is a view cut along A-A line in FIG. 16A.

FIG. 16C is a view cut along B-B line in FIG. 16A.

FIG. 17A is a perspective view illustrating the insulation wall 21 of the plug 4, the movable electrode terminals 4a and 4b in a forward portion 21A thereof, and the movable electrode terminal 4d and 4e in a rearward portion 21B thereof.

FIG. 17B is a left side view of the insulation wall 21.

### EMBODIMENTS FOR IMPLEMENTING THE INVENTION

Embodiments to which the present invention is applied are described below in detail, with reference to drawings. In drawings, components designated by the same reference numerals have the same or a similar configuration, and duplicate explanation thereof is omitted as appropriate. In addition, in each drawing, components or the like that are not necessary for explanation are omitted as appropriate.

### Embodiment 1

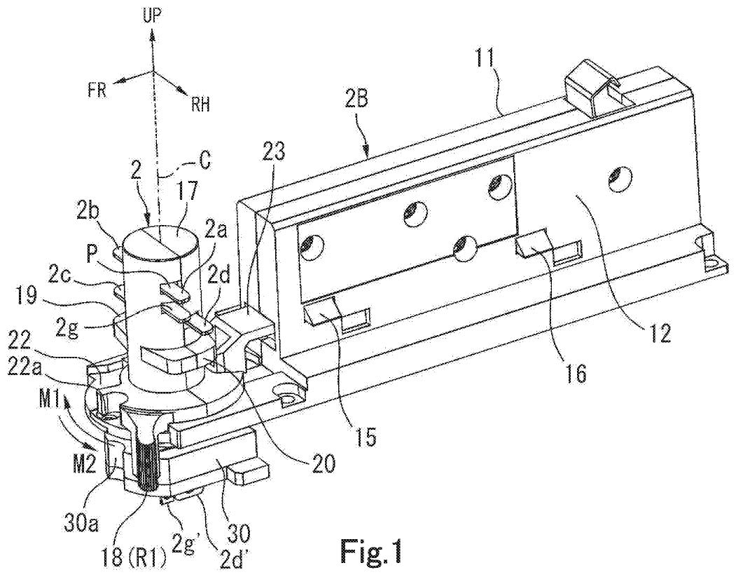

Wiring duct plugs (hereinafter simply referred to as plugs) 1 to 4 according to a first embodiment, to which the present invention is applied, are described with reference to FIGS. 1 to 17. References UP, FR, and RH designated with arrows in FIGS. 1 to 3 respectively indicate upward, front, and rightward of the plug 2 in this order.

Four plugs 1 to 4 are briefly explained below.

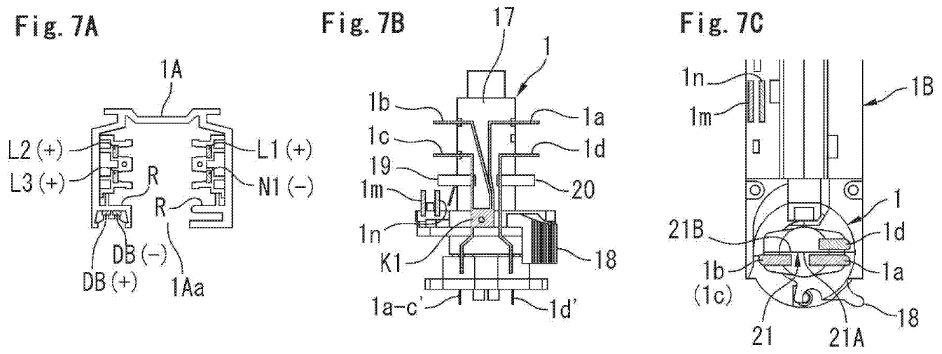

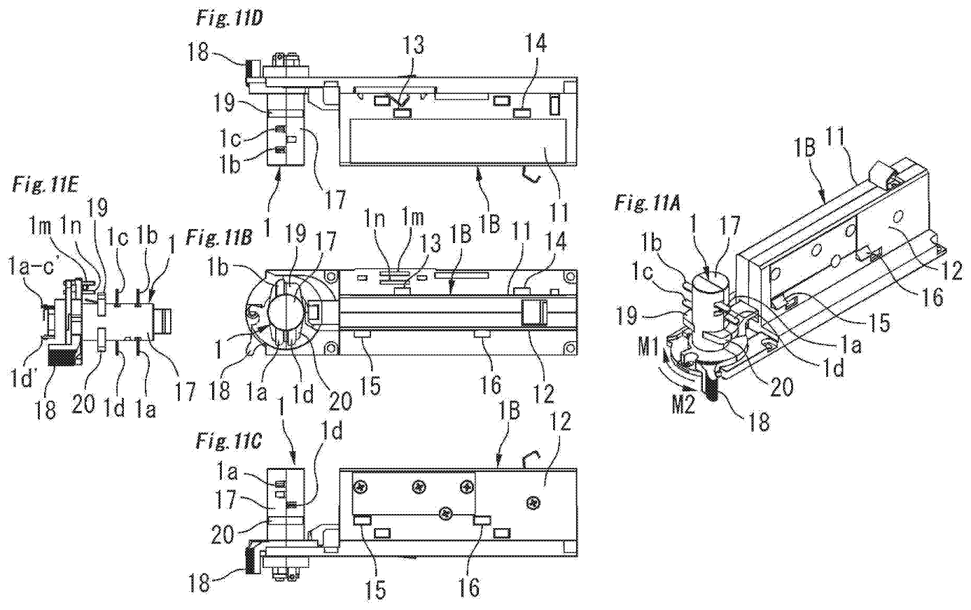

The plug 1 is a plug used in a wiring duct 1A (see FIG. 7A) available from a company A for use in Europe and Asia (hereinafter referred to as CE standard), for example. The plug 1 will be described later, with reference to FIG. 7 and FIG. 11.

The plug 1 comprises four movable electrode terminals 1a to 1d. Three of these movable electrode terminals 1a to 1c are placed in a forward portion 21A, which is forward from an insulation wall 21, and the movable electrode terminals 1a to 1c are joined into one at a base end portion K1, and electrically coupled to one non-movable electrode terminal 1a-c′. The remaining movable electrode terminal 1d is placed in a rearward portion 21B, which is rearward from the insulation wall 21, and electrically coupled to the other non-movable electrode terminal 1d′.

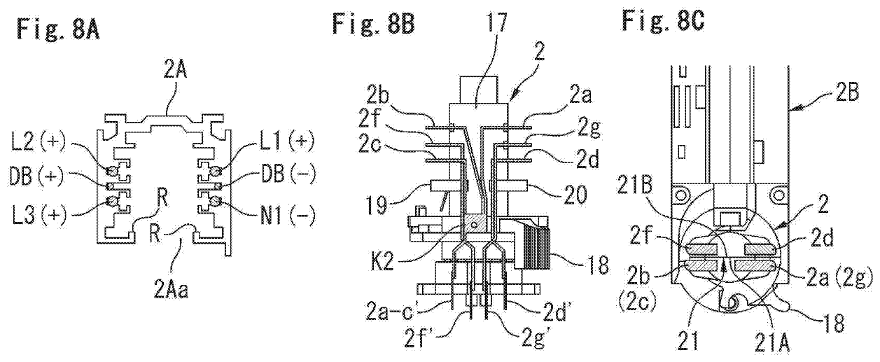

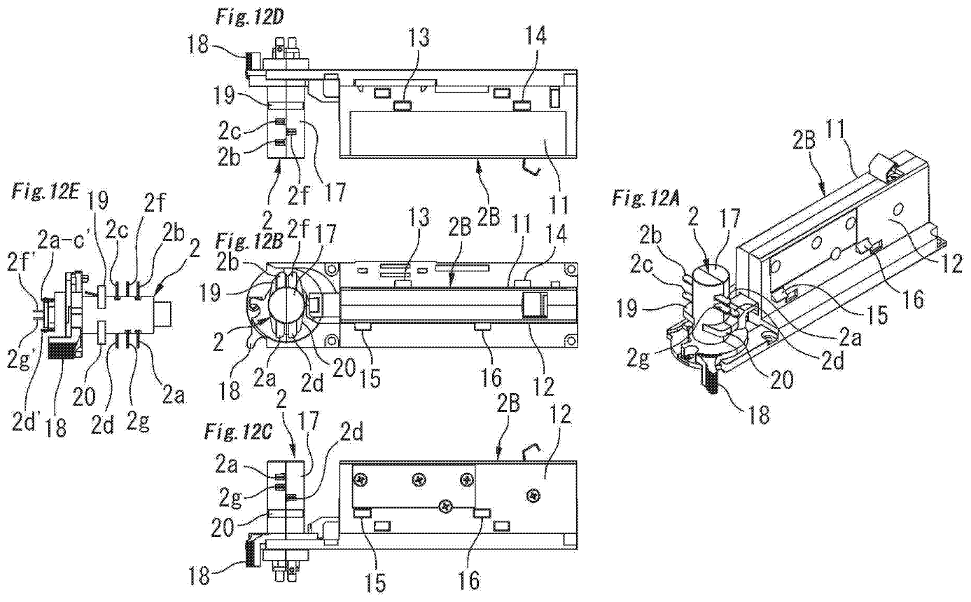

The plug 2 is a plug used in a CE-standard wiring duct 2A (see FIG. 8A) available from a company B (different from the company A), for example. The plug 2 will be described later, with reference to FIG. 8 and FIG. 12.

The plug 2 comprises four movable electrode terminals 2a to 2d. Three of these movable electrode terminals 2a to 2c are placed in a forward portion 21A, which is forward from an insulation wall 21, and joined into one at a base end portion K2, and electrically coupled to one non-movable electrode terminal 2a-c′.

The plug 2 further comprises two movable signal terminals 2f and 2g. Among them, the movable signal terminal 2g is placed in the forward portion 21A, which is forward from the insulation wall 21, and electrically coupled to a non-movable signal terminal 2g′. The remaining movable signal terminal 2f is placed in a rearward portion 21B, which is rearward from the insulation wall 21, and electrically coupled to a non-movable signal terminal 2f′.

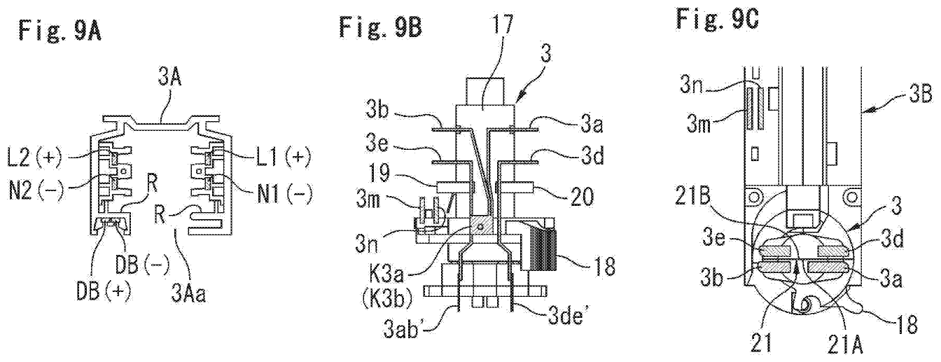

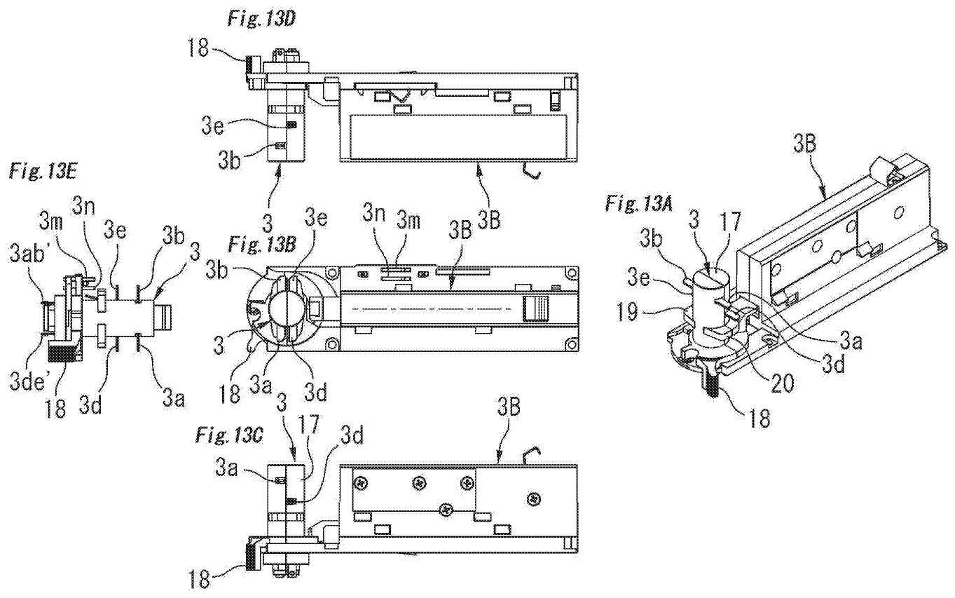

The plug 3 is a plug used in a wiring duct 3A (see FIG. 9A) available from the company A for use in U.S. and Canada (hereinafter referred to as UL standard), for example. The plug 3 will be described later, with reference to FIG. 9 and FIG. 13.

The plug 3 comprises four movable electrode terminals 3a, 3b, 3d, and 3e. Among them, the two movable electrode terminals 3a, 3b are placed in a forward portion 21A, which is forward from an insulation wall 21, and joined into one at a base end portion K3a, and electrically coupled to one non-movable electrode terminal 3ab′. The remaining two movable electrode terminals 3d and 3e are placed in a rearward portion 21B, which is rearward from the insulation wall 21, and joined into one at a base end portion K3b, and electrically coupled to the other non-movable electrode terminal 3de′.

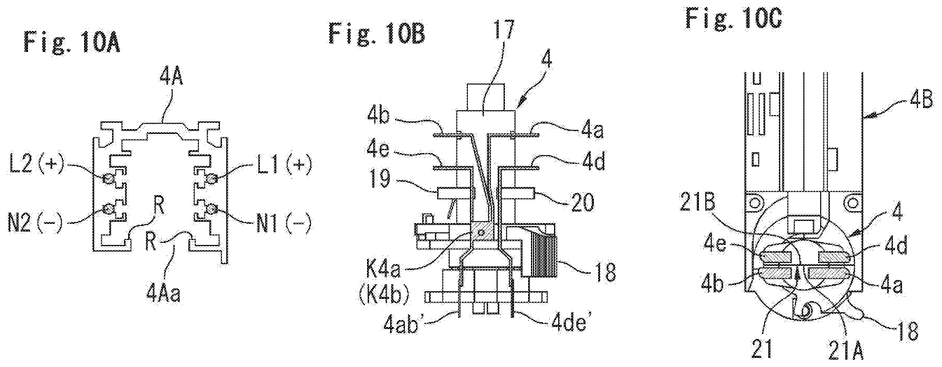

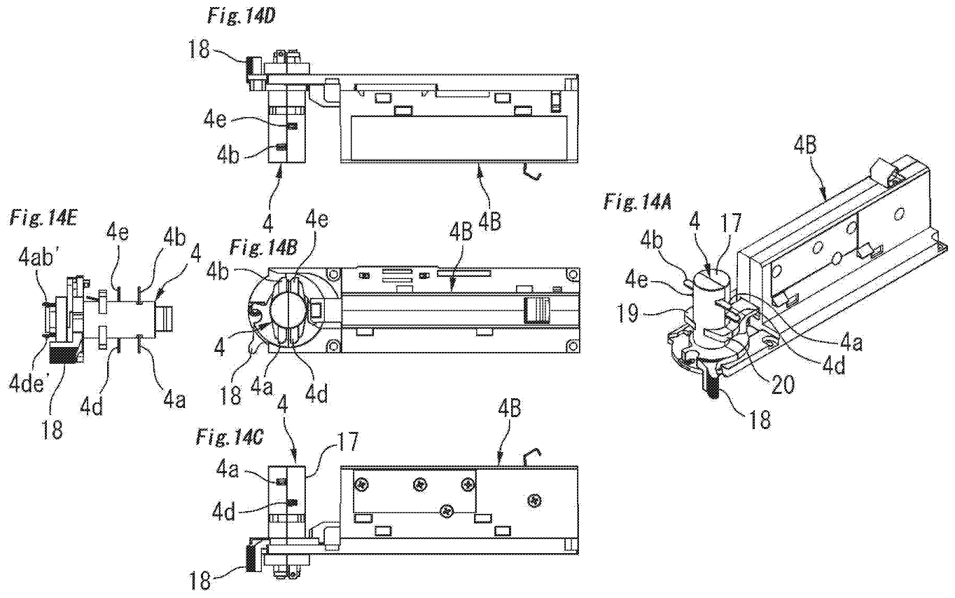

The plug 4 is a plug for use in a UL-standard wiring duct 4A available from the company B (see FIG. 10A), for example. The plug 4 will be described later, with reference to FIG. 10 and FIG. 14.

The plug 4 comprises four movable electrode terminals 4a, 4b, 4d, and 4e. Among them, the two movable electrode terminals 4a and 4b are placed in a forward portion 21A, which is forward from an insulation wall 21, and joined into one at a base end portion K4a, and electrically coupled to one non-movable electrode terminal 4ab′. The remaining two movable electrode terminals 4d and 4e are placed in a rearward portion 21B, which is rearward from the insulation wall 21, and joined into one at a base end portion K4b, and electrically coupled to the other non-movable electrode terminal 4de′.

The four plugs 1 to 4 are then described below.

First, the plug 2 is described in detail, with reference to FIGS. 1 to 6.

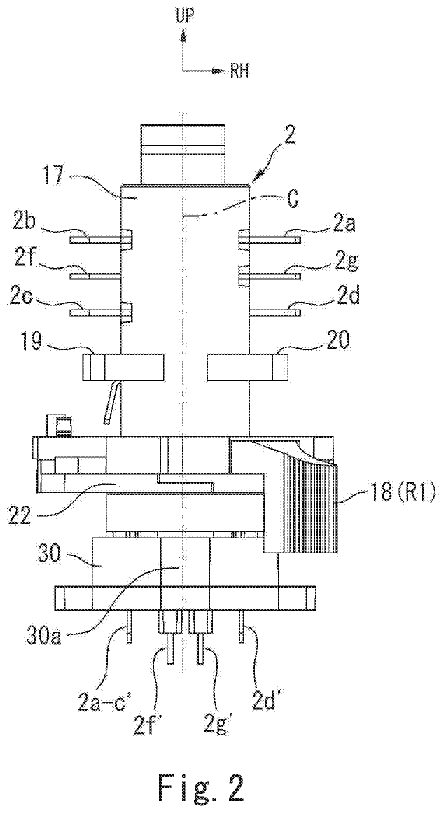

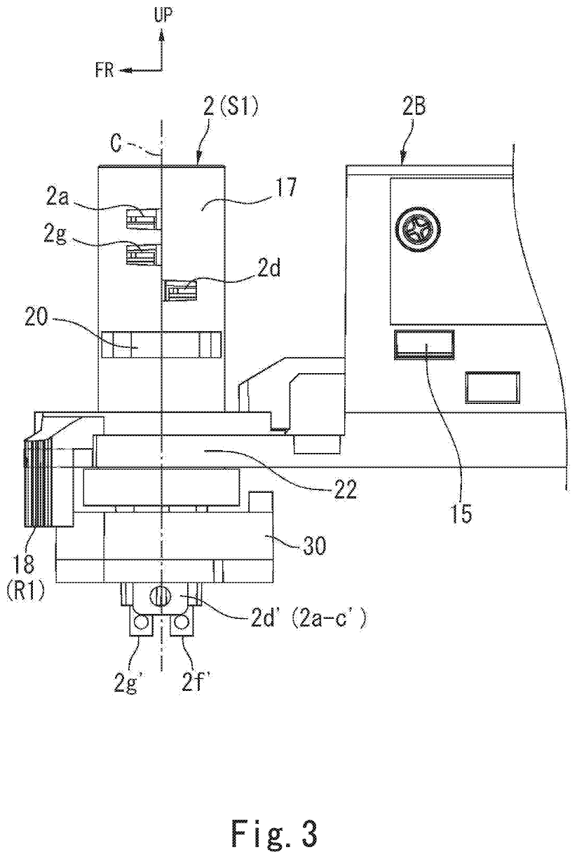

Among FIGS. 1 to 6, FIGS. 1 to 3 illustrate the plug 2. FIG. 1 is a perspective view of the plug 2. FIG. 2 is a front view of the plug 2. FIG. 3 is a right side view of the plug 2, with a portion thereof being omitted.

The plug 2 is mounted to the wiring duct 2A illustrated in FIG. 8A, when used.

A wiring duct 2A is now described with reference to FIG. 8A. FIG. 8A is a cross sectional view taken perpendicular to the longitudinal direction of the wiring duct 2A. As described above, the wiring duct 2A is a CE-standard wiring duct available from the company B, for example. The wiring duct 2A is rectangular in cross section, and has an opening 2Aa at a lower portion. In an upper portion inside the wiring duct 2A, a conductive line L1 (+) is placed on the right and a conductive line L2 (+) is placed on the left. In a middle portion inside the wiring duct 2A, a signal line DB (+) is placed on the left and a signal line DB (−) is placed on the right. In a lower portion inside the wiring duct 2A, a conductive line L3 (+) is placed on the left and a conductive line N1 (−) is placed on the right. In the opening 2Aa, rail portions R and R are provided on the left and right, respectively.

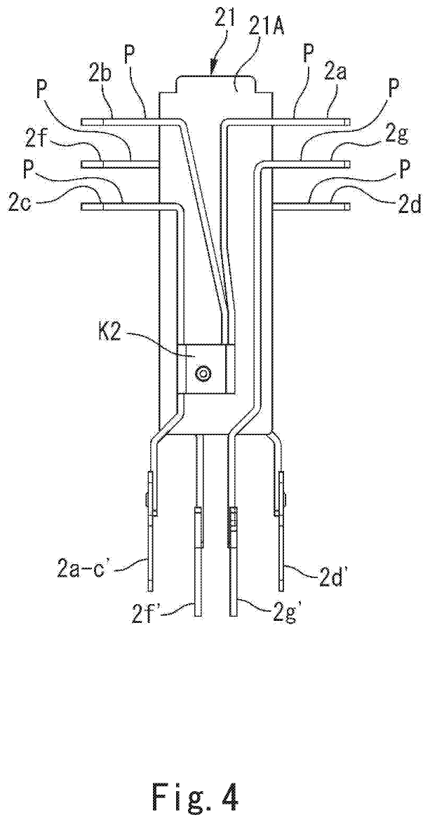

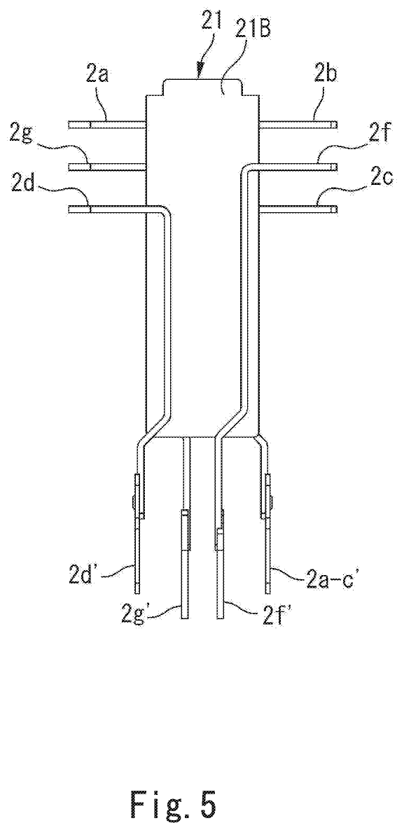

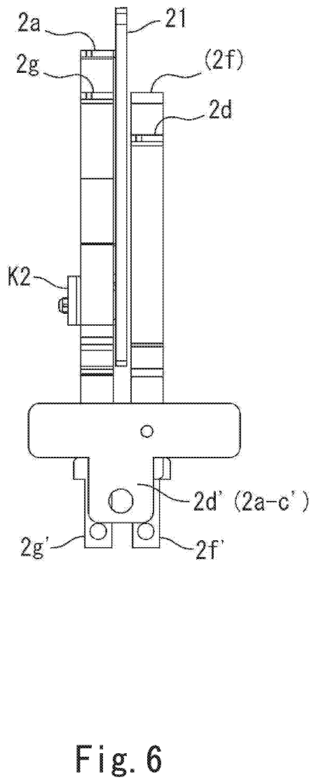

Next, the plug 2 is described with reference to FIGS. 1 to 6. FIG. 4 is a front view illustrating the insulation wall 21 of the plug 2, the movable electrode terminals 2a to 2d, movable signal terminals 2f and 2g, the non-movable electrode terminals 2a-c′ and 2d′, and the non-movable signal terminals 2f′ and 2g′. FIG. 5 is a rear view illustrating the insulation wall 21 of the plug 2, the movable electrode terminals 2a to 2d, the movable signal terminals 2f and 2g, the non-movable electrode terminals 2a-c′ and 2d′, and the non-movable signal terminals 2f′ and 2g′. FIG. 6 is a right side view illustrating the insulation wall 21 of the plug 2, the movable electrode terminals 2a and 2d, the movable signal terminal 2g, the non-movable electrode terminal 2d′, and the non-movable signal terminals 2f′ and 2g′. FIGS. 4 to 6 are respectively a front view, a rear view, and a right side view, illustrating the structure inside (interior space of) a rotator 17 and a non-movable terminal support 30, which are described later.

The plug 2 comprises the rotator 17, the pair of non-movable electrode terminals 2a-c′ and 2d′, and the plurality of movable electrode terminals 2a, 2b, 2c, and 2d, as illustrated in FIGS. 1 to 6. The term “non-movable” in the expression of the non-movable electrode terminal 2a-c′ and 2d means that its position is almost unchanged with respect to an adapter 2B, and the term “movable” in the expression of the movable electrode terminals 2a to 2d means that its position is changed (rotated nearly 90 degrees) with respect to the adapter 2B.

The rotator 17 is rotatable around a rotation axis C that is oriented in a vertical direction. The adapter 2B is disposed behind the rotator 17. The adapter 2B has a substantially rectangular prism shape, which is long in a front-rear direction and thin in a left-right direction. On a left wall surface 11 of the adapter 2B, two lug members 13 and 14 (see FIG. 12) are provided, and two lug members 15 and 16 are provided on a right wall surface 12.

The lug members 13 to 16 are capable of extending from and retracting into the left and right wall surfaces 11, 12, and each has a flat lower surface, which rides on the rails portions R, R in FIG. 8A.

A support portion 22 extending forward is formed in a lower portion of the adapter 2B. The rotator 17 is rotatably supported by the support portion 22. The rotator 17 comprises engagement pieces 19 and 20, which are extending in a left-right direction at a center portion in a vertical direction, and comprises an operation lever 18 at a lower portion in the vertical direction. When the operation lever 18 is placed at a connection position R1 illustrated in FIGS. 1 to 3, a bent portion P at a tip of the movable electrode terminals 2a to 2d, and the engagement pieces 19 and 20 are oriented to a substantially left-right direction. On the other hand, the movable electrode terminals 2a to 2d and the engagement pieces 19 and 20 are oriented substantially in a front-rear direction when the operation lever 18 is rotated approximately 90 degrees in the direction of an arrow M1 in FIG. 1. When the operation lever 18 located at a release position is rotated back approximately 90 degrees in the direction of an arrow M2, the operation lever 18 can be placed back to the connection position R1.

In the description below, the positions of the movable electrode terminals 2a to 2d oriented in a substantially left-right direction, which correspond to the connection position R1 of the operation lever 18, are referred to as “connection positions”, and the positions of the movable electrode terminals 2a to 2d oriented in a substantially front-rear direction, which correspond to the release position of the operation lever 18, are referred to as “release positions”. The movable electrode terminals 2a to 2d will be described in detail below.

A non-movable terminal support portion 30 is provided below the support portion 22 of the adapter 2B. As illustrated in FIG. 1, the non-movable terminal support portion 30 is non-movable with respect to the adapter 2B, because an outer diameter of a volt member (not shown) inserted from above into a screw hole 22a of the support portion 22 abuts an abutment portion 30a, for example. The non-movable electrode terminals 2a-c′ and 2d′ and the non-movable signal terminals 2f′ and 2g′ having plate-like shapes are secured inside the non-movable terminal support portion 30.

Interior space of the rotator 17 has a substantially cylindrical shape. In a center portion in a front-rear direction in the interior space, the insulation wall 21 illustrated in FIGS. 4 to 6 is disposed to divide the interior space into two portions, forward and rearward. The insulation wall 21 is oriented in a left-right direction, and long in a vertical direction. The plurality of movable electrode terminals 2a to 2d and the plurality of movable signal terminals 2f and 2g are placed in the interior space.

Among the plurality of movable electrode terminals 2a to 2d, three movable electrode terminals 2a to 2c are placed in a forward portion (one side) 21A, which is forward from the insulation wall 21. Two of the movable electrode terminals 2a and 2b are placed in an upper stage, where the movable electrode terminal 2a is placed on the right and the movable electrode terminal 2b is placed on the left. The movable electrode terminal 2c is placed on the left in a lower stage.

Three of the movable electrode terminals 2a to 2c are joined into one at the base end portion (lower end portion) K2. After being joined into one, it is coupled to the non-movable electrode terminal 2a-c′ described above, at the connection position illustrated in FIG. 4.

On the other hand, among the plurality of movable electrode terminals 2a to 2d, the remaining movable electrode terminal 2d is placed in the rearward portion (the other side) 21B, which is rearward from the insulation wall 21. The movable electrode terminal 2d is placed on the right in the lower stage. The movable electrode terminal 2d is coupled to the non-movable electrode terminal 2d′ described above, at the connection position illustrated in FIG. 4.

In addition, among the plurality of movable signal terminals 2f and 2g, the movable signal terminal 2g is placed in the forward portion (one side) 21A, which is forward from the insulation wall 21. The movable signal terminal 2g is placed on the right in a middle stage. The base end of the movable signal terminal 2g is coupled to the non-movable signal terminal 2g′ described above, at the connection position illustrated in FIG. 4.

Among the plurality of movable signal terminals 2f and 2g, the movable signal terminal 2f is placed in the rearward portion (the other side) 21B, which is rearward from the insulation wall 21. The movable signal terminal 2f is placed on the left in the middle stage. The base end of the movable signal terminal 2f is coupled to the non-movable signal terminal 2f′ described above, at the connection position illustrated in FIG. 4.

The plug 2 having the configuration described above as illustrated in FIGS. 1 to 3 is mounted to the wiring duct 2A illustrated in FIG. 8A, when used.

First, the operation lever 18 of the plug 2 is rotated approximately 90 degrees from the connection position R1 in the direction of the arrow M1, and placed at the release position. This operation causes the movable electrode terminals 2a to 2d, the movable signal terminals 2f and 2g, and the engaging pieces 19 and 20 to be oriented in the front-rear direction. The front-rear direction of the plug 2 is aligned with the longitudinal direction of the wiring duct 2A, and an upper portion of the plug 2 is inserted from the opening 2Aa of the wiring duct 2A. The lug members 13 to 16 ride on the rail portions R, R, and support the entire plug 2.

When the plug 2 is removed from the wiring duct 2A, the operation lever 18 is rotated from the connection position R1 in the direction of the arrow M1. This operation causes a portion of the rotator 17 to push an interlocking mechanism 23, which is located between the rotator 17 and the adapter 2B, rearward. As a result, the lug members 13 to 16 are forced to retract into the left and right wall surfaces 11 and 12.

Subsequently, the operation lever 18 is rotated in the direction of the arrow M2 and placed back to the original connection position R1. This operation causes the movable electrode terminals 2a to 2c to electrically couple the conductive lines L1 (+) to L3 (+) to the non-movable electrode terminal 2a-c′, and causes the movable electrode terminal 2d to electrically couple the conductive line N1 (−) to the non-movable electrode terminal 2d′. In parallel with this operation, the movable signal terminal 2f electrically couples the signal line DB (+) to the non-movable signal terminal 2f′, and the movable signal terminal 2g electrically couples the signal line DB (−) to the non-movable signal terminal 2g′.

Although the plug 2 has been described as being integrated with the adapter 2B in the description above, the plug 2 does not necessarily have to be integrated with the adapter 2B.

The effects and advantages of the plug 2 described above mainly with reference to FIGS. 1-6, FIG. 8, and FIG. 12 are summarized below.
According to the plug 2, the plurality of movable electrode terminals 2a to 2c are joined into one at the base end portion K2. The plurality of movable electrode terminals 2a to 2c, when placed at the connection position, thus electrically couple the plurality of conductive lines L1 (+) to L3 (+) to one of the non-movable electrode terminal 2a-c′. Therefore, for example, the plurality of movable electrode terminals 2a to 2c can electrically couple any of the plurality of conductive lines L1 (+) to L3 (+) to the one non-movable electrode terminal 2a-c′, without selecting one out of the plurality of conductive lines L1 (+) to L3 (+). In other words, no movable part for selecting (switching) one conductive line out of the plurality of conductive lines L1 (+) to L3 (+) is required, and thus the operational reliability can be improved accordingly. Note that the remaining movable electrode terminal 2d couples the remaining conductive line N1 (−) to the other non-movable electrode terminal 2d′.
According to the plug 2, the rotator 17 comprises the insulation wall 21 that divides the interior space into two portions, and the movable electrode terminals 2a to 2c whose number of terminals is one or more less than the number of the plurality of conductive lines L1 (+) to L3 (+) and N1 (−) are located in the forward portion (one side) 21A of the interior space, which is forward from the insulation wall 21, and the remaining movable electrode terminal 2d is located in the rearward portion (the other side) 21B of the interior space, which is rearward from the insulation wall 21. Therefore, for example, the movable electrode terminals 2a to 2c of positive(+) side, and the movable electrode terminal 2d of negative(−) side can be clearly separated by the insulation wall 21.
According to the plug 2, the plurality of movable electrode terminals 2a to 2d have a deformation center O in the vicinity of the base end portion, thereby a long distance from a bent portion P at the tip to the deformation center O can be obtained. Therefore, it is possible to increase a stroke S of the bent portion P of the movable electrode terminals 2a to 2d, and to place the movable electrode terminals 2a to 2d to the connection position with a relatively small force.
According to the plug 2, in addition to the plurality of movable electrode terminals 2a to 2d, the pair of movable signal terminal 2f, 2g are provided, and the plurality of movable electrode terminals 2a to 2d and the pair of movable signal terminals 2f and 2g are all located in a narrow interior space of the rotator 17.
According to the plug 2, the one movable signal terminal 2g is located in the forward portion (one side) 21A of the insulation wall 21, and the other movable signal terminal 2f is located in the rearward portion (the other side) 21B of the insulation wall 21. In this way, the one movable signal terminal 2g and the other movable signal terminal 2f can be clearly separated by the insulation wall 21.
According to the plug 2, the pair of movable signal terminals 2f and 2g have the deformation center O in the vicinity of the base end portion, thereby a long distance from the bent portion P at the tip to the deformation center O can be obtained. Therefore, it is possible to increase the stroke S of the bent portion P of the movable electrode terminals 2f and 2g, and to place the movable electrode terminals 2f and 2g to the connection position with a relatively small force.

The plugs 1 to 4 are described below, with reference to FIGS. 7 to 10. The plug 2 that will be described with reference to FIG. 8 has been described in detail with reference to FIGS. 1 to 6 described above.

FIG. 7A is a cross sectional view taken perpendicular to the longitudinal direction of the wiring duct 1A. FIG. 7B is a schematic front view of the plug 1, illustrating the movable electrode terminals 1a to 1d, and the non-movable electrode terminals 1a-c′ and 1d′. FIG. 7C is a schematic plan view of the plug 1, illustrating the movable electrode terminals 1a, 1b, and 1d. In FIG. 7B, the insulation wall 21 is omitted.

FIG. 8A is a cross sectional view taken perpendicular to the longitudinal direction of the wiring duct 2. FIG. 8B is a schematic front view of the plug 2, illustrating the movable electrode terminals 2a to 2d, the movable signal terminals 2f and 2g, the non-movable electrode terminals 2a-c′ and 2d′, and the non-movable signal terminals 2f′ and 2g′. FIG. 8C is a schematic plan view of the plug 2, illustrating the movable electrode terminals 2a, 2b, 2d, and the movable signal terminal 2f. In FIG. 8B, the insulation wall 21 is omitted.

FIG. 9A is a cross sectional view taken perpendicular to the longitudinal direction of the wiring duct 3A. FIG. 9B is a schematic front view of the plug 3, illustrating the movable electrode terminals 3a, 3b, 3d, 3e, and the non-movable electrode terminals 3ab′ and 3de′. FIG. 9C is a schematic plan view of the plug 3, illustrating the movable electrode terminals 3a, 3b, 3d and 3e. In FIG. 9B, the insulation wall 21 is omitted.

FIG. 10A is a cross sectional view taken perpendicular to the longitudinal direction of the wiring duct 4A. FIG. 10B is a schematic front view of a plug 4, illustrating the movable electrode terminals 4a, 4b, 4d, 4e, and the non-movable electrode terminals 4ab′ and 4de′. FIG. 10c is a schematic plan view of the plug 4, illustrating the movable electrode terminals 4a, 4b, 4d, and 4e. In FIG. 10B, the insulation wall 21 is omitted.

The wiring duct 1A illustrated in FIG. 7A is a CE-standard wiring duct available from the company A, as described above. The wiring duct 1A comprises conductive lines L1 (+) and L2 (+) placed in an upper stage in the interior space, and conductive lines L3 (+) and N1 (−) placed in a lower stage, along the longitudinal direction. In addition, signal lines DB (+) and DB (−) are provided at an even lower portion than the lower left stage.

The plug 1 illustrated in FIG. 7B and FIG. 7C is mounted to the wiring duct 1A. In the plug 1, the engaging piece 19 and 20 abut the wiring duct 1A from below, and the conductive lines L1 (+), L2 (+), and L3 (+) respectively contact the movable electrode terminals 1a, 1b, and 1c, in this order. The conductive line N1 (−) contacts the movable electrode terminal 1d. The movable electrode terminals 1a, 1b, and 1c are joined into one at the base end portion K1, and placed in the forward portion 21A, which is forward from the insulation wall 21 that divides the interior space of the rotator 17 into two portions, forward and rearward. In addition, the movable electrode terminal 1d is placed in the rearward portion 21B of the insulation wall 21.

Note that the signal lines DB (+) and DB (−) contact signal terminals 1m and 1 n, which have different shapes and are disposed external to the rotator 17.

The wiring duct 2A illustrated in FIG. 8A is a CE-standard wiring duct available from the company B, as described above. The wiring duct 2A comprises the conductive lines L1 (+) and L2 (+) placed in an upper stage in the interior space, the signal lines DB (+) and DB (−) placed in a middle stage, and the conductive lines L3 (+) and N1 (−) placed in a lower stage, along the longitudinal direction.

The plug 2 illustrated in FIG. 8B and FIG. 8C is mounted to the wiring duct 2A. In the plug 2, the engaging pieces 19 and 20 abut the wiring duct 2A from below, and the conductive lines L1 (+), L2 (+), and L3 (+) respectively contact the movable electrode terminals 2a, 2b, and 2c, in this order. The conductive line N1 (−) contacts the movable electrode terminal 2d. The movable electrode terminals 2a, 2b, and 2c are joined into one at the base end portion K2, and placed in the forward portion 21A, which is forward from the insulation wall 21 that divides the interior space of the rotator 17 into two portions, forward and rearward. In addition, the movable electrode terminal 2d is placed in the rearward portion 21B of the insulation wall 21.

Note that the signal lines DB (+) and DB (−) respectively contact the movable signal terminals 2f and 2g, and the movable signal terminal 2f is placed in the rearward portion 21B of the insulation wall 21, and the movable signal terminal 2g is placed in the forward portion 21A of the insulation wall 21.

The wiring duct 3A illustrated in FIG. 9A is a UL-standard wiring duct available from the company A, as described above. The wiring duct 3A comprises the conductive lines L1 (+) and L2 (+) placed in an upper stage in the interior space, and the conductive lines N1 (−) and N2 (−) placed in a lower stage, along the longitudinal direction. In addition, signal lines DB (+) and DB (−) are provided at an even lower portion than the left lower stage.

The plug 3 illustrated in FIG. 9B and FIG. 9C is mounted to the wiring duct 3A. In the plug 3, the engaging pieces 19 and 20 abut the wiring duct 3A from below, and the conductive line L1 (+) contacts the movable electrode terminal 3a, and the conductive line L2 (+) contacts the movable electrode terminal 3b. In addition, the conductive line N1 (−) contacts the movable electrode terminal 3d, and the conductive line N2 (−) contacts the movable electrode terminal 3e. The movable electrode terminals 3a and 3b are joined into one at the base end portion K3a, and placed in the forward portion 21A, which is forward from the insulation wall 21. In addition, the movable electrode terminals 3d and 3e are joined into one at the base end portion K3b, and placed in the rearward portion 21B, which is rearward from the insulation wall 21.

Note that the signal lines DB (+) and DB (−) contact signal terminals 3m and 3n, which have different shapes and are disposed external to the rotator 17.

The wiring duct 4A illustrated in FIG. 10A is a UL-standard wiring duct available from the company B, as described above. The wiring duct 4A comprises the conductive lines L1 (+) and L2 (+) placed in an upper stage in the interior space, and the conductive lines N1 (−) and N2 (−) placed in a lower stage, along the longitudinal direction.

The plug 4 illustrated in FIG. 10B and FIG. 10c is mounted to the wiring duct 4A. In the plug 4, the engaging piece 19 and 20 abut the wiring duct 4A from below, and the conductive line L1 (+) contacts the movable electrode terminal 4a and the conductive line L2 (+) contacts the movable electrode terminal 4b. In addition, the conductive line N1 (−) contacts the movable electrode terminal 4d, and the conductive line N2 (−) contacts the movable electrode terminal 4e. The movable electrode terminals 4a and 4b are joined into one at the base end portion K4a, and placed in the forward portion 21A, which is forward from the insulation wall 21. In addition, the movable electrode 4d and 4e are joined into one at the base end portion K4b, and placed in the rearward portion 21B, which is rearward from the insulation wall 21.

The plugs 1 to 4 used in the wiring ducts 1A to 4A are further explained below, with reference to FIGS. 11 to 14.

FIG. 11A is a perspective view illustrating the plug 1 used in the wiring duct 1A in FIG. 7A. FIG. 11B is a plan view thereof. FIG. 11C is a right side view thereof. FIG. 11D is a left side view thereof. FIG. 11E is a front view thereof.

FIG. 12A is a perspective view illustrating the plug 2 used in the wiring duct 2A in FIG. 8A. FIG. 12B is a plan view thereof. FIG. 12C is a right side view thereof. FIG. 12D is a left side view thereof. FIG. 12E is a front view thereof.

FIG. 13A is a perspective view illustrating the plug 3 used in the wiring duct 3A in FIG. 9A. FIG. 13B is a plan view thereof. FIG. 13C is a right side view thereof. FIG. 13D is a left side view thereof. FIG. 13E is a front view thereof.

FIG. 14A is a perspective view illustrating the plug 4 used in the wiring duct 4A in FIG. 10A. FIG. 14B is a plan view thereof. FIG. 14C is a right side view thereof. FIG. 14D is a left side view thereof. FIG. 14E is a front view thereof.

As illustrated in FIG. 11A to FIG. 11E, the plug 1 is configured integrally with the adapter 1B that is used in the wiring duct 1A in FIG. 7A.

The adapter 1B has a long rectangular prism shape in the front-rear direction (same as the longitudinal direction of the wiring duct 1A), and has left and right wall surfaces 11 and 12, on which extendable and retractable lug members 13 to 16 are provided. The adapter 1B is suspended at an attachment position of the wiring duct 1A, with its upper portion being entered inside the wiring duct 1A, and the lug members 13 to 16 being suspended on the rail portions R, R of the wiring duct 1A.

The plug 1 is rotatably supported by the adapter 1B. The plug 1 comprises a substantially cylindrical rotator 17, whose rotation axis C (see FIG. 1) is oriented in the vertical direction, and the operation lever 18 secured in the vicinity of a lower end of the plug 1. The movable electrode terminals 1a to 1d protrude from the rotator 17. The movable electrode terminals 1a and 1b protrude from an upper stage of the rotator 17 in the left and right directions, and the movable electrode terminals 1c and 1d protrude from a lower stage in the left and right directions. From a lower portion of the movable electrode terminals 1c and 1d, the engaging pieces 19 and 20 extend in the left and right directions at a substantially same height as the lug members 13 to 16 described above.

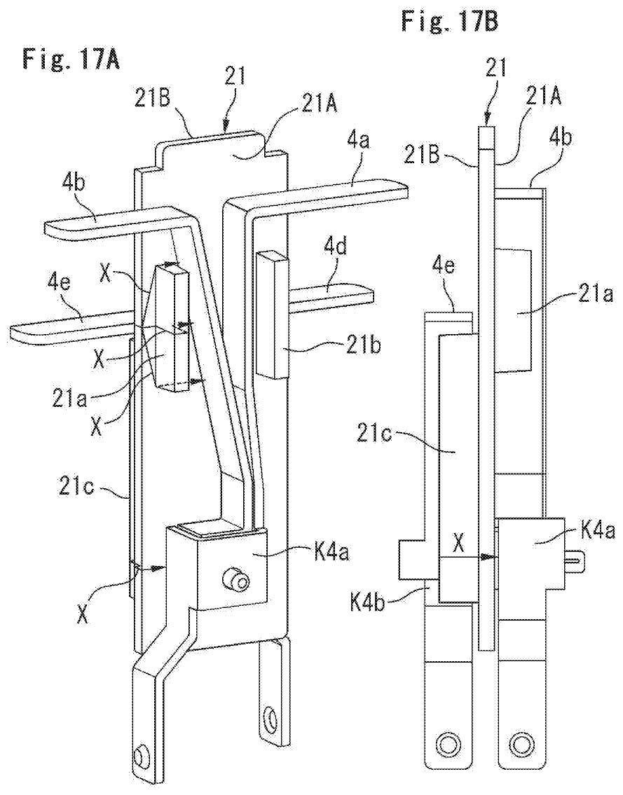

Regarding the positions of the movable electrode terminals 1a to 1c in the front-rear direction, the movable electrode terminals 1a to 1d are placed in the forward portion 21A of the insulation wall 21 and the movable electrode terminal 1d is placed in the rearward portion 21B of the insulation wall 21, interposing the insulation wall 21 (see FIG. 17) that divides the interior space of the rotator 17 into two portions, forward and rearward.

In the plug 1, the movable electrode terminals 1a to 1d and the engagement pieces 19 and 20 are oriented in the front-rear direction, when the operation lever 18 is rotated substantially 90 degrees in the direction of the arrow M1 from the connection position R1 illustrated in FIG. 11. This operation allows attachment to the wiring duct 1A by means of the lug members 13 to 16. The movable electrode terminals 1a to 1d and the engagement pieces 19 and 20 are oriented to the left-right direction when the operation lever 18 is rotated approximately 90 degrees in the direction of the arrow M2, back to the original connection position R1. This operation causes the movable electrode terminals 1a to 1c to contact the conductive lines L1 (+) to L3 (+), and causes the movable electrode terminal 1d to contact the conductive line N1 (−).

As illustrated in FIGS. 12A to 12E, the plug 2 is configured integrally with the adapter 2B that is used in the wiring duct 2A in FIG. 8A. This configuration enables the movable signal terminals 2f and 2g to contact the non-movable signal terminals 2f′ and 2g′, respectively.

The plug 2 has a configuration similar to that of the plug 1, excepting the structure inside the rotator 17, i.e. the structure of the movable electrode terminals. Differences have been described above with reference to FIG. 8B and FIG. 8C.

As illustrated in FIGS. 13A to 13E, the plug 3 is configured integrally with the adapter 3B that is used in the wiring duct 3A in FIG. 9A.

The plug 3 has a configuration similar to that of the plug 1, excepting the structure inside the rotator 17, i.e., the structure of the movable electrode terminals. Differences have been described above with reference to FIG. 9B and FIG. 9C.

As illustrated in FIG. 14A to FIG. 14E, the plug 4 is configured integrally with the adapter 4B that is used in the wiring duct 4A in FIG. 10A.

The plug 4 has a configuration similar to that of the plug 1, excepting the structure inside the rotator 17, i.e., the structure of the movable electrode terminals. Differences have been described above with reference to FIG. 10B and FIG. 10c.

The effects and advantages of the plugs 1 described mainly with reference to FIGS. 7 and 11 are summarized below.
According to the plug 1, the plurality of movable electrode terminals 1a to 1c are joined into one at the base end portion K1. Thus, the plurality of movable electrode terminals 1a to 1c, when placed at the connection position, electrically couple the plurality of conductive lines L1 (+) to L3 (+) to the one non-movable electrode terminal 1a-c′. Therefore, for example, the plurality of movable electrode terminals 1a to 1c can electrically couple any of the plurality of conductive lines L1 (+) to L3 (+) to the one non-movable electrode terminal 1a-c′, without selecting one out of the plurality of conductive lines L1 (+) to L3 (+). In other words, no movable part for selecting (switching) one conductive line out of the plurality of conductive lines L1 (+) to L3 (+) is required, and thus it is possible to increase the operational reliability accordingly. Note that the remaining movable electrode terminal 1d couples the remaining conductive line N1 (−) to the other non-movable electrode terminal 1d′.
According to the plug 1, the rotator 17 comprises the insulation wall 21 that divides the interior space into two portions. The movable electrode terminals 1a to 1c, whose number of terminals is one or more less than the number of the plurality of conductive lines L1 (+) to L3 (+) and N1 (−), are placed in the forward portion (one side) 21A of the interior space, and the remaining movable electrode terminal 1d is placed in the rearward portion (the other side) 21B of the interior space, interposing the insulation wall 21. Therefore, for example, the movable electrode terminals 1a to 1c of positive(+) side can be clearly separated from the movable electrode terminal 1d of negative(−) side, by the insulation wall 21.
According to the plug 1, the plurality of movable electrode terminals 1a to 1d have their deformation centers O in the vicinity of the base end portion, and thus a long distance from the bent portion P at the tip to the deformation center O can be obtained. Therefore, it is possible to increase the stroke S of the bent portion P of the movable electrode terminals 1a to 1d, and place the movable electrode terminals 1a to 1d at the connection position with a relatively small force.

The effects and advantages of the plug 2 described mainly with reference to FIGS. 8 and 12 are as described above.

Next, the effects and advantages of the plug 3 described mainly with reference to FIGS. 9 and 13 are summarized below.
According to the plug 3, the plurality of movable electrode terminals 3a and 3b are joined into one at the base end portion K3a, and the plurality of movable electrode terminals 3d and 3e are joined into one at the base end portion K3b. Therefore, the plurality of movable electrode terminals 3a and 3b, when placed at the connection position, electrically couple the plurality of conductive lines L1 (+), and L2 (+) to the one non-movable electrode terminal 1ab′. In addition, the plurality of movable electrode terminal 3d and 3e, when placed at the connection position, electrically couple the plurality of conductive lines N1 (−) and N2 (−) to the other non-movable electrode terminal 1de′. Therefore, for example, the plurality of movable electrode terminals 3a and 3b can electrically couple either of the conductive lines L1 (+) or L2 (+) to the one non-movable electrode terminal 1ab′, without selecting one out of the plurality of conductive lines L1 (+) and L2 (+). In addition, the plurality of movable electrode terminal 3d and 3e can electrically couple either of the conductive line N1 (−) or N2 (−) to the one non-movable electrode terminal 1de′, without selecting one out of the plurality of conductive lines N1 (−) and N2 (−). In other words, no movable part for selecting (switching) one conductive line out of the plurality of conductive lines L1 (+) and L2 (+) is required, and no movable part for selecting (switching) one conductive line out of the plurality of conductive lines N1 (−) and N2 (−) is required, and thus it is possible to increase the operational reliability accordingly.
According to the plug 3, the rotator 17 comprises the insulation wall 21 that divides the interior space into two portions, and the movable electrode terminals 3a and 3b, whose number of terminals is one or more less than the number of the plurality of conductive lines L1 (+), L2 (+), N1 (−), and N2 (−), are placed in the forward portion (one side) 21A of the interior space, which is forward from the insulation wall 21, and the remaining movable electrode terminals 3d and 3e are placed in the rearward portion (the other side) 21B of the interior space, which is rearward from the insulation wall 21. Therefore, for example, the movable electrode terminals 3a and 3b of positive(+) side can be clearly separated from the movable electrode terminal 3d and 3e of negative(−) side, by the insulation wall 21.
According to the plug 3, the plurality of movable electrode terminals 3a and 3b have their deformation centers O in the vicinity of the base end portion K3a, and the plurality of movable electrode terminal 3d and 3e have their deformation centers O in the vicinity of the base end portion K3b, thereby a long distance from the bent portion P at the tip to the deformation center O can be obtained. Therefore, it is possible to increase the stroke S of the bent portion P of the movable electrode terminals 3a, 3b, 3d, and 3e, and place the movable electrode terminals 3a, 3b, 3d, and 3e at the connection position with a relatively small force.

The effects and advantages of the plug 4 described mainly with reference to FIGS. 10 and 14 are similar to those of the plug 3 described above, and thus explanation thereof is omitted.

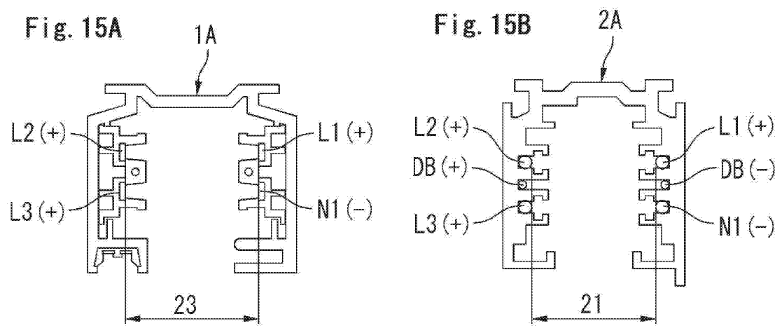

FIG. 15A is an enlarged view of the wiring duct 1A in FIG. 7A. FIG. 15B is an enlarged view of the wiring duct 2A in FIG. 8A.

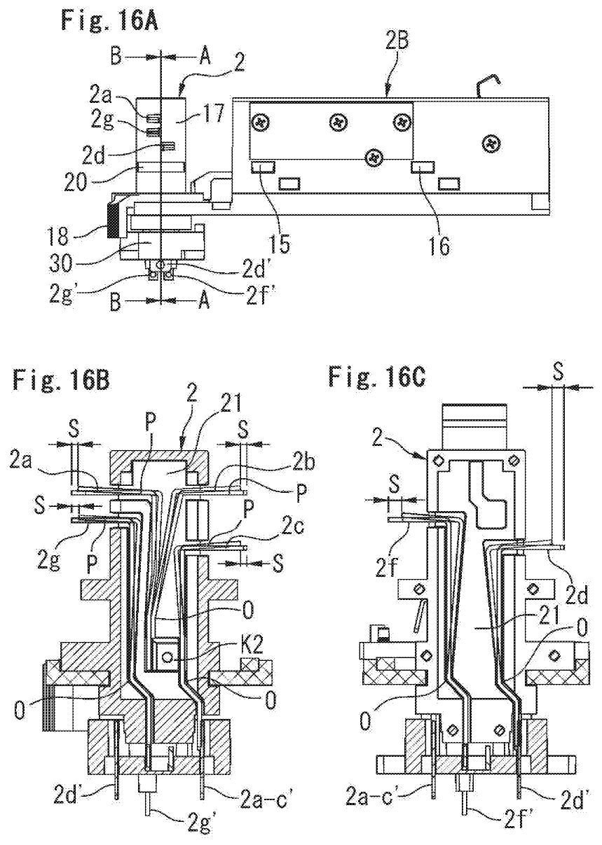

FIG. 16A is a right side view of the plug 2. FIG. 16B is a view cut along A-A line in FIG. 16A. FIG. 16C is a view cut along B-B line in FIG. 16A.

As illustrated in FIG. 15A, in the wiring duct 1A, the distance between the left and right conductive lines L1 (+) and L2 (+) is 23 mm, for example. On the other hand, as illustrated in FIG. 15B, in the wiring duct 2A, the distance between the left and right conductive lines L1 (+) and L2 (+) is 21 mm for example, resulting in a difference of 2 mm (=23 mm−21 mm).

In order to compensate for this 2-mm difference, the deformation centers O of the movable electrode terminals 2a to 2d and the movable signal terminal 2f and 2g are located at a position as far as possible from the bent portion P at their respective tips, as illustrated in FIG. 16A to FIG. 16C, thereby the stroke S is secured.

As a result, the plugs 1 and 2 available from different companies A and B of the same CE-standard can be made in common, simply by changing the internal structure of their respective rotators 17. In other words, simply by changing the arrangement or the like of the movable electrode terminals 2a to 2d and the movable signal terminals 2f and 2g, other components such as the rotator 17, adapter, non-movable terminal support portion 30 or the like can be in common, without any change.

In addition, by setting the deformation center O of the plug 2 to a position as far as possible from the bent portion P at the tip of the plug 2 in this manner, it is possible to reduce resistance caused by the plug 2 when the plug 2 is rotated in the direction of the arrow M2 (see FIG. 11). Same can be said for the plugs 3 and 4 that are available from different companies A and B, but having the same UL standard.

In addition, as illustrated in FIGS. 16A to 16C, the movable electrode terminals 2a, 2b, 2c of the plug 2 are joined into one at the base end portion K2 so that the movable terminal 2a, 2b, 2c are electrically integrated, and placed in the forward portion 21A of the insulation wall 21. The movable electrode terminal 2d is placed in the rearward portion 21B of the insulation wall 21.

By electrically connecting and integrating the base end portion K2 of the movable electrode terminals 2a, 2b, 2c in this manner, a constructor who uses the wiring duct 2A may install three conductive lines L1 (+), L2 (+), and L3 (+), or may install one of them.

In the description above, the plug 2 has been explained as an example, but the explanation is also applicable to the plug 1, 3, or 4.

FIG. 17A is a perspective view illustrating the insulation wall 21 of the plug 4, the movable electrode terminals 4a and 4b in its forward portion 21A, and the movable electrode terminal 4d, 4e in its rearward portion 21B. FIG. 17B is a left side view of the insulation wall 21.

As illustrated in FIGS. 17A and 17B, the insulation wall 21 comprises insulation ribs 21a and 21b in the forward portion 21A, and an insulation rib 21c in the rearward portion 21B, in order to obtain a creepage distance X.

In the embodiments described above, the plugs 1 to 4 are configured integrally with the adapters 1B to 4B, respectively, but the plugs 1 to 4 may be configured separately from the adapters 1B to 4B.

### DESCRIPTION OF REFERENCES

1-4: Plug (Plug for wiring duct)
1A-4A: Wiring duct
1B-4B: Adapter
1a-1d, 2a-2d, 3a, 3b, 3d, 3e, 4a, 4b, 4d, 4e: Movable electrode terminal
2a-c′, 2d′: Non-movable electrode terminal
2f, 2g: Movable signal terminal
2f′, 2g′: Non-movable signal terminal
17: Rotator
21: Insulation wall
21A: Forward portion (one side)
21B: Rearward portion (the other side)
DB (+), DB (−): Signal line
K1, K2, K3a, K3b, K4a, K4b: Base end portion
L1 (+), L2 (+), L3 (+), N1 (−), N2 (−): Conductive line
O: Deformation center
P: Bent portion
R1: Connection position

1. A wiring duct plug for use mounted in a wiring duct in which a plurality of conductive lines are installed, the plug comprising:
a rotatable rotator;
a pair of non-movable electrode terminals; and
a plurality of movable electrode terminals, rotating with the rotator and placed either at a connection position for electrically coupling the plurality of conductive lines to the pair of non-movable electrode terminals, or at a release position for releasing electrical connection,
wherein, when placed at the connection position, among the plurality of movable electrode terminals, a plurality of movable electrode terminals whose number of terminals is one or more less than the number of the plurality of conductive lines are coupled to conductive lines whose number of lines is one or more less than the number of the plurality of conductive lines, respectively, and are joined into one at a base end portion and coupled to one of the non-movable electrode terminals, and the remaining movable electrode terminal couples the remaining conductive lines to the other non-movable electrode terminal.

2. The wiring ducting plug according to claim 1:
wherein the rotator comprises an insulation wall that divides interior space into two portions, and
the movable electrode terminals whose number of the terminals is one or more less than the number of the plurality of conductive lines are placed in one of the portions of the interior space divided by the insulation wall,
the remaining movable electrode terminal is placed in the other portion of the interior space divided by the insulation wall.

3. The wiring ducting plug according to claim 1:
wherein the plurality of movable electrode terminals comprise a deformation center in the vicinity of the base end portion.

4. The wiring ducting plug according to claims 1:
wherein the wiring duct plug is for use mounted in a wiring duct in which a plurality of conductive lines and a pair of signal lines are installed, the plug comprising:
a pair of non-movable signal terminals; and
a pair of movable signal terminals rotating with the rotator, wherein the pair of movable signal terminals are configured to: when placed at the connection position, electrically couple the pair of signal lines to the pair of non-movable signal terminals; and when placed at a release position, release electrical connection,
wherein, when placed at the connection position, the one of the movable signal terminals couples the one of the signal lines and the one non-movable signal terminal, and the other movable signal terminal couples the other signal line and the other non-movable signal terminal.

5. The wiring duct plug according to claim 4:
wherein the one of the movable signal terminals is placed in one of the portions divided by the insulation wall, and
the other one of the movable signal terminals is placed in the other portion divided by the insulation wall.

6. The wiring duct plug according to claim 4:
wherein the pair of movable signal terminals have a deformation center in the vicinity of the base end portion.
